(19) United States
(12) Patent Application Publication
(10) Pub. No.: US 2024/0247145 A1
(43) Pub. Date: Jul. 25, 2024

(54) SINGLE-LAYER OR MULTILAYER TUBULAR STRUCTURE BASED ON RECYCLED POLYAMIDE

(71) Applicant: ARKEMA FRANCE, COLOMBES (FR)

(72) Inventors: Thomas PRENVEILLE, Serquigny (FR); Marjorie MARCOURT, Serquigny (FR); Sébastien VAUTIER, Serquigny (FR)

(73) Assignee: ARKEMA FRANCE, COLOMBES (FR)

(21) Appl. No.: 18/577,402

(22) PCT Filed: Jul. 7, 2022
(86) PCT No.: PCT/FR2022/051363

§ 371 Date: Jan. 8, 2024

(30) Foreign Application Priority Data
Jul. 9, 2021 (FR) FR2107457

(51) Int. Cl. C08L 77/06; B29C 48/09; B29K 77/00; B32B 27/34; C08J 3/12; C08J 11/08

(52) U.S. Cl. CPC C08L 77/06; B29C 48/09; B32B 27/34; C08J 3/12; C08J 11/08; B29K 2077/00; B32B 2272/00; B32B 2597/00; C08J 2377/06; C08L 2205/025; C08L 2207/00

(57) ABSTRACT

A composition including: (a) 30% to 99.8% by weight by weight of recycled material from a used single-layer and/or multilayer tube and/or tank having initially transported or contained motor vehicle fluids, the tube and/or the tank having a composition which predominantly includes at least one polyamide, the used tube and/or the used tank having been ground into granules and the fluid residues present in the tube and/or tank having been totally or partially extracted, (b) up to 70% of a semicrystalline aliphatic polyamide, (c) up to 0.2% of an additive, the polyamide of the used tube and/or the used tank having functions resulting from oxidation reactions chosen from the primary amide functions, nitriles, terminal methyl groups, alkenes, formamides, imides, carboxylic acids and alcohols and mixtures thereof, in a mole ratio greater than that of the same polyamide constituting a non-used tube and/or tank which has not yet transported or contained motor vehicle fluids.

### TECHNICAL FIELD

The present invention relates to a composition obtained from used polyamide pipes from motor vehicles, to single-layer or multilayer tubular structures comprising at least one layer consisting of said composition, and to a process for manufacturing same.

### PRIOR ART

Every year, several million motor vehicles become end-of-life worldwide. An end-of-life motor vehicle (ELV) contains numerous toxic and pollutant products (liquids or solids): used oil, batteries, air-conditioning fluid, explosive elements from airbags, etc. When processed under unsuitable conditions, this waste may result in ground and water pollution, and also accidents. ELVs are thus considered hazardous waste.

A large amount of the vehicle's components can be recovered and recycled, in the form of second-hand spare parts or raw materials. Parts intended for re-use (headlights, indicators, engine, radiator, starter, hood, wings, doors, etc.) are dismantled and stored for resale.

Carcasses and non-recyclable parts (ferrous and non-ferrous metals, plastics, glass, rubber, etc.) are separated and crushed for repurposing or landfill.

The European Directive 2000/53/EC on end-of-life vehicles set a reuse and repurposing level of 95% by weight per vehicle from 2015.

This means that only 5% should remain as ultimate waste, i.e. waste which is unfit for processing under current technical and economic conditions, and which will be incinerated or disposed of in special landfill sites.

The 95% that are reused and repurposed undergo the following processes:
Energy recovery: use of waste (oils, tires, plastics, etc.) as a means of producing energy, by direct incineration with or without other waste;
Material repurposing: Reuse or repurposing: a new use for a part which retains its same use and is not transformed, or
Recycling: operation directed toward introducing materials from waste into the production cycle, in total or partial replacement for virgin material.

A motor vehicle contains a large number of pipes, notably pipes for transporting fluids such as air, oil (for example for cooling the automatic gearbox (transmission oil cooler (TOC)), water, urea solution, a glycol-based coolant, fuel such as gasoline, in particular bio-gasoline or diesel, in particular bio-diesel, or hydrogen.

It also contains tanks that have stored said fluid in the vehicle.

These pipes may be single-layer and/or multilayer tubular structures, in particular based on polyamide(s), and likewise the tanks may be single-layer and/or multilayer structures, in particular based on polyamide(s).

When the motor vehicle is end-of-life, the various tubes present therein are generally very or too degraded to be reused as such, in tube form, without risk or without this leading to excessively degraded working properties.

Specifically, tubes, notably under engine hoods, are placed in a severe thermo-oxidative environment due to the heat generated by the engine, which may typically be up to 150° C., and the presence of air and thus oxygen. Each 10° C. increase in temperature typically results in a halving of tube life, and similarly in the degradation of certain additives of said tubes, such as stabilizers.

Hitherto, end-of-life motor vehicle pipes or fuel tanks have not been reused, and are often incinerated. This then contributes to global warming, the reduction of which has become one of the major challenges of the 21st century.

Moreover, many motor vehicle manufacturers have set themselves the more or less long-term objective of recycling 100% of the vehicles they produce, in order to achieve an environmental impact equal to zero.

Consequently, supplying these manufacturers with recycled pipes is of prime importance, enabling them to reduce the amount they have to dispose of or incinerate.

The reuse, without modification, of tubes taken from end-of-life cars is not envisaged for the following reasons:

Analysis of end-of-life tubes has shown that they have become stiffer relative to a new tube: the end-of-life tube has a higher threshold stress (loss of additives, and crystallization induced by the working environment). This stiffening is a problem, as the tube risks being damaged during disassembly and assembly on a new vehicle (tubes particularly stressed during feathering).

Furthermore, the tubes at the end of their life have been thermoformed during installation into the new vehicle to fit exactly into the vehicle model, which is a model that will probably no longer be in production 10 to 15 years after the sale of said vehicle.

A tank has a specific shape suitable for each vehicle model, which changes regularly.

Conventionally, when a used tube is to be recycled, it is first crushed, then recompounded and possibly reformulated before being extruded to manufacture a new tube.

It is necessary to find ways of reusing or recycling these tubes in order to limit the environmental impact of the motor vehicle industry, and also to limit the costs of recycling the used pipe in order to provide motor vehicle manufacturers with pipes at a price that is compatible with the range of vehicle sold.

The present invention thus relates to a composition comprising:
(a) 30% to 99.8% by weight, in particular 50% to 99.8% by weight of recycled material from a used single-layer and/or multilayer tube and/or tank having initially transported or contained motor vehicle fluids, in particular air, oil, water, urea solution, a glycol-based coolant, or a fuel such as gasoline, in particular alcohol-blended gasoline, bio-gasoline or diesel, in particular bio-diesel, or hydrogen, said tube and/or said tank consisting of a composition which predominantly comprises at least one polyamide,
said used single-layer and/or multilayer tube and/or said used tank having been ground into granules and the fluid residues present in said tube and/or tank having been totally or partially extracted, before or after grinding of said tube and/or tank,
(b) up to 70%, in particular up to 50% of a semicrystalline aliphatic polyamide,
(c) up to 45% by weight of at least one impact modifier, in particular from 1% to 45% by weight of at least one impact modifier, notably from 2% to 45% by weight of at least one impact modifier,
(d) up to 20% by weight of at least one plasticizer,
(e) up to 0.2% of an additive, said polyamide of said used tube and/or said used tank having functions resulting from oxidation reactions chosen from primary amide functions, nitriles, terminal methyl groups, alkenes, formamides, imides, carboxylic acids and alcohols and mixtures thereof, in a mole ratio relative to the amide functions greater than that of the same polyamide constituting a non-used tube and/or tank which has not yet transported or contained motor vehicle fluids.

Advantageously, said used single-layer and/or multilayer tube and/or said used tank are only ground into granules, which excludes grinding followed by recompounding with or without reformulation.

Said used single-layer and/or multilayer tube and/or used tank thus exclude any virgin single-layer and/or multilayer tube and/or tank, i.e. a tube or tank which has never transported or contained a motor-vehicle fluid, although its intended purpose would be said transportation of motor vehicle fluids. This therefore de facto excludes any scrap from manufacturing single-layer and/or multilayer tubes and/or tanks for transporting or storing motor vehicle fluids.

In one embodiment, said composition of said tube and/or tank excludes polyphenylene sulfide (PPS).

The term “motor vehicle” means any vehicle with a thermal, electric or hybrid engine equipped with wheels or caterpillar tracks, excluding a flying vehicle.

The motor vehicle may be a two-wheeled, three-wheeled, four-wheeled or caterpillar-tracked vehicle.

For example, it is chosen from an electric bicycle, a moped, a motorcycle, a side car, a car, a van, a tractor, a truck, a bus, a coach, a snowmobile, an autochenille, a bulldozer, a snow groomer and a tank.

In particular, it is chosen from a car, a van, a truck, a bus and a coach.

In particular, it is chosen from internal combustion engine cars, vans, trucks, buses and coaches.

When tubes or tanks for transporting or storing fluids are used in motor vehicles, new species resulting from oxidation mechanisms, notably amide functions and/or methylene alpha to said amide functions, such as primary amide functions, nitriles, terminal methyl groups, alkenes, formamides, imides, carboxylic acids and alcohols, are seen in the polyamides of which said tubes or tanks are composed. Said functions may be detected by infrared spectrometry.

The terminal methyl groups are for example the CH3 group of CH3(CH2)n groups.

The alkenes correspond to CH2═CH—.

Thus, the absorption band from 1700 to 1740 cm⁻¹ corresponds to an imide, that from 1680 to 1720 cm⁻¹ to the carbonyl of the carboxylic acid and that from 3580 to 3670 cm⁻¹ corresponds to the alcohol function of the carboxylic acid.

The absorption band from 3580 to 3670 cm⁻¹ corresponds to the free alcohol function.

The amide function is characterized on the one hand by a pair of absorption bands at 3100 to 3500 cm⁻¹ and 1560 to 1640 cm-1, corresponding to the NH group of the amide, and on the other hand by the absorption band at 1650 to 1700 cm-1, corresponding to the carbonyl group of the amide.

Infrared allows detection of the presence or absence of said new species resulting from oxidation mechanisms.

Quantification of said new species resulting from oxidation mechanisms is performed by proton NMR in dichloromethane-d2, with the addition of HFIP (hexafluoroisopropanol) to dissolve the polyamide.

For example, 20 mg of polymer may be dissolved in 0.7 mL of solvent with an HFIP/CD2CI2 ratio of ⅓.

Some of the functions mentioned below may, for example, be observed in 13C NMR. Thus, the line at 36 ppm corresponds to the CH2 alpha to the primary amide, and that at 34 ppm corresponds to the CH2 alpha to the carboxylic acid. These species may be quantified by integrating the area under the lines and comparing them with the area under the 37.1 ppm line corresponding to the secondary amide.

Similarly, the lines corresponding to the carbonyl groups of the primary amide, carboxylic acid and secondary amide functions are observed at 181.2 ppm, 179.6 ppm and 177.4 ppm, respectively.

The line at 16.7 ppm corresponds to the CH2 alpha to the nitrile group.

The formamide group gives chemical shifts at 163.0 ppm and 166.3 ppm.

Other functions mentioned above may be observed in proton NMR (1H NMR) with the solvent HFIP/CD2CI2 as described above. The line for the formamide CHO groups emerges at 7.92 and 8.01 ppm. The line corresponding to the CH2 groups alpha to the primary amides may be observed at 2.30 ppm. The 0.9 ppm line corresponds to the CH3 groups of the CH3-(CH2)n type. The line at 2.40 ppm corresponds to the CH2 alpha to the nitrile function. Similar to what is described for carbon NMR, the ratios of new functions relative to secondary amides can be determined by integrating the area under the lines and comparing them to the area under the line corresponding to the CH2 alpha to the secondary amide (2.20 ppm).

The inventors have thus found, surprisingly, that the use of at least 30% by weight, in particular at least 50% by weight, of recycled material based on partially oxidized polyamides and originating from a used and only ground single-layer and/or multilayer tube and/or tank, the fluid residues present in said tube and/or tank having been totally or partially extracted, before or after grinding said tube and/or tank, with a semicrystalline aliphatic polyamide, and optionally an additive, allowed the constitution of a composition which can then be transformed into a tube or tank whose mechanical properties are equivalent to those of a tube or tank derived from non-recycled and non-used material, i.e. a new tube or tank.

The expression “said used single-layer and/or multilayer tube and/or said used tank” means that said single-layer and/or multilayer tube and/or said tank were originally fitted to a motor vehicle and were used to transport or store a motor vehicle fluid during the service life of the motor vehicle.

The expression “the fluid residues present in said tube and/or tank having been totally or partially extracted, before or after grinding of said tube and/or tank” means that said tube and/or tank has undergone a treatment allowing said fluid to be partially or totally removed.

When said tube and/or tank has transported air, this is, for example, an “air brake” pipe used for vehicle braking. Even if the air is completely eliminated after treatment, the fact remains that the pipe has been exposed to engine heat and chemical agents such as ZnCl2, and will thus have the oxidation functions described, which distinguishes it from a virgin pipe.

Throughout the description, the term “tube” or “pipe” may be used and denotes the same thing.

The recycled material thus corresponds to a used single-layer and/or multilayer tube and/or tank which originally transported or contained motor vehicle fluids.

It does not in any case correspond to a material resulting from a tube or tank manufacturing process and which would correspond either to material losses or scraps or to tubes or tanks not in compliance with the specifications and which have never transported a motor vehicle fluid, and which would then be reintroduced into said process.

As Regards the Composition Comprising Constituents a)+b)+c)+d)+e).

The composition comprises:
(a) 30% to 99.8% by weight, in particular 50% to 99.8% by weight of recycled material from a used single-layer and/or multilayer tube and/or tank, said tube and/or said tank consisting of a composition which predominantly comprises at least one polyamide,
said used single-layer and/or multilayer tube and/or said used tank having only been ground into granules and the fluid residues present in said tube and/or tank having been totally or partially extracted, before or after grinding of said tube and/or tank,
(b) up to 70%, in particular up to 50% of a semicrystalline aliphatic polyamide,
(c) up to 45% by weight of at least one impact modifier, in particular from 1% to 45% by weight of at least one impact modifier, notably from 2% to 45% by weight of at least one impact modifier,
(d) up to 20% by weight of at least one plasticizer,
(e) up to 0.2% of an additive,
the sum of the constituents a)+b)+c)+d)+e) being equal to 100%.
said polyamide of said used tube and/or said used tank having functions resulting from oxidation reactions chosen from the primary amide functions, nitriles, terminal methyl groups, alkenes, formamides, imides, carboxylic acids and alcohols and mixtures thereof, in a mole ratio relative to the amide functions greater than that of the same polyamide constituting a non-used tube and/or tank which has not yet transported or contained motor vehicle fluids.

The term “fluid” denotes a gas or liquid used in motor vehicles, in particular air, oil, water, urea solution, a glycol-based coolant, or a fuel such as gasoline, in particular alcohol-blended gasoline, bio-gasoline or diesel, in particular bio-diesel, or hydrogen.

Advantageously, said fluid denotes fuels, in particular gasoline, in particular alcohol-blended gasoline, bio-gasoline or diesel, in particular bio-diesel.

The term “gasoline” denotes a mixture of hydrocarbons originating from the distillation of petroleum, to which may be added additives or alcohols such as methanol or ethanol, alcohols possibly being predominant components in some cases.

The expression “alcohol-blended gasoline” denotes a gasoline to which methanol or ethanol have been added. It also denotes an E95 type gasoline, which does not contain any petroleum distillation products.

The expression “polyamide-based” means at least 50% by weight of polyamide in the layer.

The semicrystalline aliphatic polyamide used in b) may contain impact modifiers and/or plasticizers and/or additives.

The oxidation reactions or oxidation mechanisms correspond to oxidation notably of the amide functions and/or of the methylene alpha (a) to said amide functions.

The used tube and/or tank to be reused or in other words recycled (single-layer and/or multilayer for both tube and tank) is thus removed from the motor vehicle, in particular the automobile, and undergoes grinding.

Advantageously, it undergoes grinding only, which excludes grinding followed by recompounding with or without reformulation.

Such recompounding is conventionally performed by introducing the ground material at least once into an extruder, notably of the twin-screw co-rotating type, or of the co-kneader (Buss) type, where the ground material is remixed by melting, with or without the addition of at least one compound chosen from a semicrystalline aliphatic polyamide, whether or not of recycled origin, at least one impact modifier, a plasticizer, an additive and antistatic fillers. The molten material exits the extruder as rods, which are cooled and cut into pellets, which are then placed in an extruder to manufacture the single-layer or multilayer tubular structure.

On the other hand, the fluid residues present in said tube and/or tank are extracted totally or partially, before or after grinding of said tube and/or tank.

In a first embodiment, said mole ratio of functions produced by oxidation reactions ranges from 1/10 000 to 1/20.

The concentrations may be measured by proton or carbon NMR in dichloromethane-d2, with the addition of HFIP (hexafluoroisopropanol) to dissolve the polyamide.

In a first variant, said mole ratio of imide functions ranges from 1/1000 to 1/20, notably from 1/500 to 1/20, in particular from 1/200 to 1/50.

In a second variant, said mole ratio of carboxylic acid functions ranges from 1/5000 to 1/20, notably from 1/3000 to 1/50, very advantageously from 1/500 to 1/15.

In a third variant, said mole ratio of alcohol functions ranges from 1/1000 to 1/20, advantageously from 1/1000 to 1/25 and very advantageously from 1/200 to 1/50.

In a fourth variant, said mole ratio of primary amide functions ranges from 1/2000 to 1/20, advantageously from 1/1000 to 1/100 and very advantageously from 1/1000 to 1/500.

In a fifth variant, said mole ratio of nitrile functions ranges from 1/1000 to 1/20, advantageously from 1/500 to 1/15 and very advantageously from 1/100 to 1/10.

In a sixth variant, said mole ratio of terminal methyl functions ranges from 1/5000 to 1/50, advantageously from 1/2000 to 1/100 and very advantageously from 1/1000 to 1/200.

In these different variants, said ratio of said functions is calculated as a function of the integration of the secondary amide peak.

Since the composition consists of at most 99.8% recycled material, it is then necessary to add a polyamide (identical or different) of non-recycled origin to the material to be recycled and/or an impact modifier and/or a plasticizer and/or optionally an additive. This may be done by dry blending (a mixture of recycled ground material and virgin granules, whether formulated or non-formulated, and/or optionally the additive) or by compounding, advantageously by dry blending.

This dry mix is then introduced into the extruder during the manufacture of the single-layer or multilayer tubular structure.

The nomenclature used to define polyamides is described in the standard ISO 1874-1:2011 “Plastics—Polyamide (PA) moulding and extrusion materials—Part 1: Designation” and is well known to those skilled in the art.

For the purposes of the invention, the term “polyamide” denotes either a homopolyamide or a copolyamide.

For the purposes of the invention, throughout the description, the term “semicrystalline polyamide” denotes polyamides which have a melting point (Tm) and a heat of fusion ΔH>25 J/g, in particular >40 J/g, notably>45 J/g, and also a glass transition temperature (Tg) as determined by DSC according to the standard ISO 11357-1: 2016 and ISO 11357-2 and 3: 2013, at a heating rate of 20 K/min.

Said at least one aliphatic semicrystalline polyamide is obtained from the polycondensation of at least one lactam, or from the polycondensation of at least one amino acid, or from the polycondensation of at least one diamine X with at least one dicarboxylic acid Y.

When said at least one aliphatic semicrystalline polyamide is obtained from the polycondensation of at least one lactam, said at least one lactam may be chosen from a C6 to C18, preferentially C10 to C18, more preferentially C10 to C12 lactam. A C6 to C18 lactam is notably caprolactam, decanolactam, undecanolactam or lauryllactam.

When said at least one aliphatic semicrystalline polyamide is obtained from the polycondensation of at least one lactam, it may thus comprise a single lactam or several lactams.

Advantageously, said at least one aliphatic semicrystalline polyamide is obtained from the polycondensation of a single lactam and said lactam is chosen from lauryllactam and undecanolactam, advantageously lauryllactam.

When said at least one aliphatic semicrystalline polyamide is obtained from the polycondensation of at least one amino acid, said at least one amino acid may be chosen from a C6 to C18, preferentially C10 to C18, more preferentially C10 to C12 amino acid.

A C6 to C18 amino acid is notably 6-aminohexanoic acid, 9-aminononanoic acid, 10-aminodecanoic acid, 10-aminoundecanoic acid, 12-aminododecanoic acid and 11-aminoundecanoic acid and also derivatives thereof, notably N-heptyl-11-aminoundecanoic acid.

When said at least one aliphatic semicrystalline polyamide is obtained from the polycondensation of at least one amino acid, it may thus comprise a single amino acid or several amino acids.

Advantageously, said aliphatic semicrystalline polyamide is obtained from the polycondensation of a single amino acid and said amino acid is chosen from 10-aminodecanoic acid, 11-aminoundecanoic acid and 12-aminododecanoic acid, advantageously 11-aminoundecanoic acid.

When said at least one aliphatic semicrystalline polyamide is obtained from the polycondensation of at least one C4-C36, preferentially C5-C18, preferentially C5-C12, more preferentially C10-C12 diamine X, with at least one C4-C36, preferentially C6-C18, preferentially C6-C12, more preferentially C10-C12, diacid Y, then said at least one diamine X is an aliphatic diamine and said at least one diacid Y is an aliphatic diacid.

The diamine may be linear or branched. Advantageously, it is linear.

Said at least one C4-C36 diamine X may be chosen in particular from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine X is C5-C18 and chosen from 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one diamine X is C5-C12, and is chosen in particular from 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, said at least one diamine X is C6-C12, and is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, the diamine X used is C10-C12, in particular chosen from 1,10-decamethylenediamine, 1,11-undecamethylenediamine and 1,12-dodecamethylenediamine.

Said at least one C4-C36 dicarboxylic acid Y may be chosen from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one dicarboxylic acid Y is C6-C18 and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

Advantageously, said at least one dicarboxylic acid Y is C6-C12 and is chosen from adipic acid, suberic acid, azelaic acid, sebacic acid, undecanedioic acid and dodecanedioic acid.

Advantageously, said at least one dicarboxylic acid Y is C10-C12 and is chosen from sebacic acid, undecanedioic acid and dodecanedioic acid.

When said aliphatic semicrystalline polyamide is obtained from the polycondensation of at least one diamine X with at least one dicarboxylic acid Y, it may thus comprise a single diamine or several diamines and a single dicarboxylic acid or several dicarboxylic acids.

Advantageously, said aliphatic semicrystalline polyamide is obtained from the polycondensation of a single diamine X with a single dicarboxylic acid Y.

The term “comprising predominantly at least one aliphatic-type polyamide” means that said composition of the layer (1) comprises at least 50% by weight of at least one aliphatic polyamide relative to the total weight of said composition.

Advantageously, said composition of the layer (1) comprises at least 60% by weight, notably at least 70% by weight, in particular at least 80% by weight, more particularly at least 90% by weight of at least one aliphatic polyamide relative to the total weight of said composition.

Said composition of the layer (1) consists of at least 30%, in particular at least 50% and not more than 99.8%, of recycled material from a single-layer and/or multilayer tube and/or tank, said tubes and tanks being used components and having been intended for the transportation or storage of motor vehicle fluids.

This means either that the “at least one predominant polyamide” of said composition corresponds in its entirety to what is referred to as “at least 50% recycled material”, or that at least 50% by weight of the total constituents of the composition are of recycled origin from a single-layer tube, or a multilayer tube, or a tank or a mixture thereof.

The recycled material may come from a single-layer and/or multilayer tube and/or a single-layer and/or multilayer tank, said single-layer and/or multilayer tubes being used components and having been intended for transporting motor vehicle fluids and/or the single-layer and/or multilayer tank being a used component and having been intended for storing motor vehicle fluid. Said tube or tank is thus a used tube or a used tank, i.e. it has been used for at least one year for the transportation or storage of said fluid defined above. Said single-layer tube consists of a composition comprising a semicrystalline aliphatic polyamide and optionally impact modifiers and/or additives and/or plasticizers and/or antistatic fillers.

Said multilayer tube comprises at least one layer consisting of a composition comprising a semicrystalline aliphatic polyamide and optionally impact modifiers and/or additives. It may thus comprise other layers consisting of a thermoplastic polymer other than a semicrystalline aliphatic polyamide, for instance polyethylene, polypropylene, semiaromatic polyamide or polyethylene vinyl alcohol (EVOH).

Said tank may be single-layered and consist of a composition comprising a semicrystalline aliphatic polyamide and optionally impact modifiers and/or additives and/or plasticizers and/or antistatic fillers.

Said tank may be multilayered and comprises at least one layer consisting of a composition comprising a semicrystalline aliphatic polyamide and optionally impact modifiers and/or additives. It may thus comprise other layers consisting of a thermoplastic polymer other than a semicrystalline aliphatic polyamide, for instance polyethylene, polypropylene, semiaromatic polyamide or polyethylene vinyl alcohol (EVOH).

It goes without saying that the single-layer tube may also be a single-layer tube blend, i.e. for instance two types of single-layer tube each consisting of a different semicrystalline aliphatic polyamide, for example PA11 and PA12.

It also goes without saying that the multilayer tube may also be a mixture of different multilayer tube types, provided that at least one of the layers of one of the multilayer tube types consists of a semicrystalline aliphatic polyamide.

It also goes without saying that the single-layer tank may also be a single-layer tank blend, i.e. for example two types of single-layer tank each consisting of a different semicrystalline aliphatic polyamide, for example PA11 and PA12.

It also goes without saying that the multilayer tank may also be a mixture of different multilayer tank types, provided that at least one of the layers of one of the multilayer tank types consists of a semicrystalline aliphatic polyamide.

If the mixed tubes or tanks are mutually incompatible, then the addition of a third semicrystalline aliphatic polyamide noted B having an average number of carbon atoms per nitrogen atom CB is present to compatibilize them.

If A is noted as the polyamide of the tube and C as the polyamide of the tank, and if they are incompatible:
then CB is comprised between (C_{A}+C_{C})/2-2 and (C_{A}+C_{C})/2+2, advantageously between (C_{A}+C_{C})/2-1 and (C_{A}+C_{C})/2+1.

Said single-layer and/or multilayer tube, which has been used for transporting motor vehicle fluids and is thus a used component, undergoes several different treatments so that it can be recycled:

The fluid residues are either first extracted totally or partially and then the single-layer and/or multilayer tube and/or tank are ground, or the single-layer and/or multilayer tube and/or tank are ground and then the fluid residues are extracted totally or partially from the ground material obtained.

In one embodiment, the extraction of said fluid residues is performed by means of washing or ventilation.

Washing may be performed before or after grinding.

Advantageously, washing is performed using a fluid such as supercritical CO2 or solvents such as methanol, ethanol, in particular methanol, or a mixture of supercritical CO2 and solvent.

This washing notably allows the removal of fluids that are miscible with methanol, such as fuels, oil and coolant liquids.

Advantageously, ventilation is performed by means of an inertized oven or desiccator.

In one embodiment, extraction is performed after grinding by means of a degassing zone in said extruder or by means of other apparatus allowing degassing in the molten state.

Advantageously, the used pipes before or after grinding are cleaned to remove any residual oligomers that may be present in the used pipes.

Fluids such as fuels, when stored in a tank or transported in a tube, degrade the polymer of the constituent layer of the tube in contact with the fluid, resulting in the appearance of oligomers which must be cleaned before the tubes can be recycled.

The oligomers are cleaned by washing with water or polar solvents such as methanol or ethanol.

PA 6 and 66, for example, are systematically washed in hot water (about 100 to 120° C.) to remove as much caprolactam as possible.

Alternatively, the oligomers may be distilled.

In the case of extraction by ventilation, this operation may be performed after grinding in an inertized oven, or else during extrusion of the tubular structure if the extruder is equipped with a degassing zone.

The fluid residues may be any fluid originally transported by the single-layer or multilayer tube or stored in the tank.

Extraction may also be performed before or after milling, for example by placing under vacuum if the fluid residues are volatile.

In one embodiment, said composition consists of:
(a) 30% to 99.8% by weight, in particular 50% to 99.8% by weight of recycled material from a used single-layer and/or multilayer tube and/or tank having initially transported or contained motor vehicle fluids, in particular air, oil, water, urea solution, a glycol-based coolant, or a fuel such as gasoline, in particular alcohol-blended gasoline, bio-gasoline or diesel, in particular bio-diesel, or hydrogen, said tube and/or said tank consisting of a composition which predominantly comprises at least one polyamide, said used single-layer and/or multilayer tube and/or said used tank having been ground into granules and the fluid residues present in said tube and/or tank having been totally or partially extracted, before or after grinding of said tube and/or tank,
(b) up to 70%, in particular up to 50% of a semicrystalline aliphatic polyamide,
(c) up to 45% by weight of at least one impact modifier, in particular from 1% to 45% by weight of at least one impact modifier, notably from 2% to 45% by weight of at least one impact modifier,
(d) up to 20% by weight of at least one plasticizer,
(e) up to 0.2% of an additive, the sum of the constituents a)+b)+c)+d)+e) being equal to 100%.

In another embodiment, said composition consists of:
(a) 30% to 99.8% by weight, in particular 50% to 99.8% by weight of recycled material from a used single-layer and/or multilayer tube and/or tank having initially transported or contained motor vehicle fluids, in particular air, oil, water, urea solution, a glycol-based coolant, or a fuel such as gasoline, in particular alcohol-blended gasoline, bio-gasoline or diesel, in particular bio-diesel, or hydrogen, said tube and/or said tank consisting of a composition which predominantly consists of at least one polyamide, said used single-layer and/or multilayer tube and/or said used tank having been ground into granules and the fluid residues present in said tube and/or tank having been totally or partially extracted, before or after grinding of said tube and/or tank,
(b) up to 70%, in particular up to 50% of a semicrystalline aliphatic polyamide,
(c) up to 45% by weight of at least one impact modifier, in particular from 1% to 45% by weight of at least one impact modifier, notably from 2% to 45% by weight of at least one impact modifier,
(d) up to 20% by weight of at least one plasticizer,
(e) up to 0.2% of an additive,
the sum of the constituents a)+b)+c)+d)+e) being equal to 100%.

Advantageously, in these last two embodiments, said used single-layer and/or multilayer tube and/or said used tank are only ground, excluding grinding followed by recompounding with or without reformulation.

Advantageously, in these last three embodiments, said tube and/or said tank consists of a composition which consists of at least one polyamide.

According to a first variant, said composition comprises the abovementioned constituents a)+b)+c)+d)+e) in the following proportions:
(a) 30% to 87.8% by weight, in particular 50% to 87.8% by weight of recycled material from a used single-layer and/or multilayer tube and/or tank having initially transported or contained motor vehicle fluids, in particular air, oil, water, urea solution, a glycol-based coolant, or a fuel such as gasoline, in particular alcohol-blended gasoline, bio-gasoline or diesel, in particular bio-diesel, or hydrogen, said tube and/or said tank consisting of a composition which predominantly comprises at least one polyamide,
(b) from 10% to 70%, in particular from 10% to 50% of a semicrystalline aliphatic polyamide,
(c) from 1% to 45% by weight of at least one impact modifier, notably from 2% to 45% by weight of at least one impact modifier,
(d) from 1% to 20% by weight of at least one plasticizer,
(e) up to 0.2% of an additive,
the sum of the constituents a)+b)+c)+d)+e) being equal to 100%.

According to a second variant, said composition consists of the abovementioned constituents a)+b)+c)+d)+e) in the following proportions:
(a) 30% to 87.8% by weight, in particular 50% to 87.8% by weight of recycled material from a used single-layer and/or multilayer tube and/or tank having initially transported or contained motor vehicle fluids, in particular air, oil, water, urea solution, a glycol-based coolant, or a fuel such as gasoline, in particular alcohol-blended gasoline, bio-gasoline or diesel, in particular bio-diesel, or hydrogen, said tube and/or said tank consisting of a composition which predominantly comprises at least one polyamide,
(b) from 10% to 70%, in particular from 10% to 50% of a semicrystalline aliphatic polyamide,
(c) from 1% to 45% by weight of at least one impact modifier, notably from 2% to 45% by weight of at least one impact modifier,
(d) from 1% to 20% by weight of at least one plasticizer,
(e) up to 0.2% of an additive, the sum of the constituents a)+b)+c)+d)+e) being equal to 100%.

Advantageously, in these two variants, said used single-layer and/or multilayer tube and/or said used tank is only ground, excluding grinding followed by recompounding with or without reformulation.

In these two variants and the associated embodiment, advantageously, said tube and/or tank consists of a composition which consists predominantly of at least one polyamide; notably, it consists of at least one polyamide.

According to another aspect, the present invention relates to a single-layer or multilayer tubular structure (MLT) intended for transporting motor vehicle fluids, in particular air, oil, water, urea solution, a glycol-based coolant, or a fuel such as gasoline, in particular alcohol-blended gasoline, bio-gasoline or diesel, in particular bio-diesel, or hydrogen, comprising at least one layer (1) consisting of a composition as defined above.

In one embodiment, said tubular structure has during the first storage of gasoline, notably alcohol-blended gasoline, a maximum of 0.3 g/m² of insoluble extract, advantageously a maximum of 0.2 g/m².

In one embodiment, said tubular structure has 30%, notably 40%, in particular 50% less insoluble extract than the same tubular structure produced from non-recycled material during the first storage of gasoline, notably of alcohol-blended gasoline.

The single-layer tubular structure of the invention intended for transporting motor vehicle fluids allows the proportion of extractables to be greatly reduced, as determined by a test which consists in filling a tubular structure with alcohol-blended gasoline of the FAM-B type and heating the assembly at 60° C. for 96 hours, and then emptying it by filtering the fluid into a beaker.

The insoluble extracts present during filtration on the filter are weighed after drying and represent less than 0.3 g/m².

The soluble extracts are quantified by allowing the filtrate in the beaker to evaporate at room temperature and then weighing the residue. The proportion of soluble extracts is advantageously less than or equal to about 15 g/m² of tube internal surface area.

The alcohol-blended gasoline FAM B is described in the standards DIN 51604-1: 1982, DIN 51604-2: 1984 and DIN 51604-3: 1984.

Briefly, alcohol-blended gasoline FAM A is first prepared with a mixture of 50% of toluene, 30% of isooctane, 15% of diisobutylene and 5% of ethanol then FAM B is prepared by mixing 84.5% of FAM A with 15% of methanol and 0.5% of water.

FAM B consists in total of 42.3% of toluene, 25.4% of isooctane, 12.7% of diisobutylene, 4.2% of ethanol, 15% of methanol and 0.5% of water.

Said tubular structure has an extractable content lower than that of the same tubular structure made from non-recycled, i.e. virgin or original material during the first storage of gasoline, in particular alcohol-blended gasoline, and in particular a proportion of insoluble extract lower by 30%, in particular 40%, in particular 50% relative to the proportion present in the same tubular structure but made from non-recycled or virgin material.

### As Regards Layer (1)

Layer (1) consists of a composition predominantly comprising at least one semicrystalline aliphatic polyamide, said composition consisting of at least 30%, in particular at least 50%, of recycled material originating from a single-layer and/or multilayer tube which has been used for transporting motor vehicle fluids and/or from a single-layer and/or multilayer tank which has been used for storing motor vehicle fluids.

Since the composition of the layer (1) consists of at most 99.8% recycled material, a polyamide (identical or different) of non-recycled origin must be added to the material to be recycled, and this is then performed during the passage through the extruder during the manufacture of the single-layer or multilayer tubular structure and/or an additive.

In a first variant, said composition of the layer (1) comprises:
a) at least 50% by weight, in particular from 50% to 99.8% by weight, of at least one semicrystalline aliphatic polyamide noted C having an average number of carbon atoms per nitrogen atom noted C_{C} of from 6 to 18, advantageously from 8 to 12;
b1) from 0 to 50% by weight of at least one semicrystalline aliphatic polyamide noted B and having an average number of carbon atoms per nitrogen atom noted C_{B}=C_{C}−1, preferentially C_{B}=C_{C}−2;
b2) from 0 to 50% by weight of a semicrystalline aliphatic polyamide noted A and having an average number of carbon atoms per nitrogen atom noted C_{A}=C_{B}−1, preferentially C_{A}=C_{B}−2;
c) from 0 to 45% by weight of at least one impact modifier, in particular from 1% to 45% by weight of at least one impact modifier, notably from 2% to 45% by weight of at least one impact modifier,
d) from 0 to 20% by weight of at least one plasticizer,
e) from 0 to 0.2% by weight of at least one additive,
the sum of the constituents a), b1), b2), c), d) and e) being equal to 100%.

Advantageously, in this first variant, said composition of the layer (1) comprises: b1) from 1% to 50% by weight of at least one semicrystalline aliphatic polyamide noted B and having an average number of carbon atoms per nitrogen atom noted C_{B}=C_{C}−1, preferentially C_{B}=C_{C}−2.

Advantageously, in this first variant, said composition of the layer (1) comprises: b2) from 1% to 50% by weight of a semicrystalline aliphatic polyamide noted A and having an average number of carbon atoms per nitrogen atom noted C_{A}=C_{B}−1, preferentially C_{A}=C_{B}−2.

Advantageously, in this first variant, said composition of the layer (1) comprises: b1) from 1% to 50% by weight of at least one semicrystalline aliphatic polyamide noted B and having an average number of carbon atoms per nitrogen atom noted C_{B}=C_{C}−1, preferentially C_{B}=C_{C}−2 and b2) from 1% to 50% by weight of a semicrystalline aliphatic polyamide noted A and having an average number of carbon atoms per nitrogen atom noted C_{A}=C_{B}−1, preferentially C_{A}=C_{B}−2.

Advantageously, in this first variant, said composition of the layer (1) comprises: c) from 1% to 45% by weight of at least one impact modifier, notably from 2% to 45% by weight of at least one impact modifier.

Advantageously, in this first variant, said composition of the layer (1) comprises: d) from 1% to 20% by weight of at least one plasticizer.

Advantageously, in this first variant, said composition of the layer (1) comprises: e) from 1% to 0.2% by weight of at least one additive.

All the combinations between a), b1), b2), c), d) and e) defined above are possible in this first variant.

In a second variant, said composition of the layer (1) consists of:
a) at least 50% by weight, in particular from 50% to 99.8% by weight, of at least one semicrystalline aliphatic polyamide noted C having an average number of carbon atoms per nitrogen atom noted C_{C} of from 6 to 18, advantageously from 8 to 12;
b1) from 0 to 25% by weight of at least one semicrystalline aliphatic polyamide noted B and having an average number of carbon atoms per nitrogen atom noted C_{B}=C_{C}−1, preferentially C_{B}=C_{C}−2;
b2) from 0 to 25% by weight of a semicrystalline aliphatic polyamide noted A and having an average number of carbon atoms per nitrogen atom noted C_{A}=C_{B}−1, preferentially C_{A}=C_{B}−2;
c) from 0 to 45% by weight of at least one impact modifier, in particular from 1% to 45% by weight of at least one impact modifier, notably from 2% to 45% by weight of at least one impact modifier,
d) from 0 to 20% of at least one plasticizer,
e) from 0 to 0.2% by weight of at least one additive,
the sum of the constituents a), b1), b2), c), d) and e) being equal to 100%.

All the embodiments described for the first variant are also valid for this second variant.

The polyamides noted A, B and C may be of recycled or non-recycled origin on condition that the composition of the layer (1) consists of at least 50% recycled material.

Advantageously, the Tm of the predominant semicrystalline aliphatic polyamide of layer (1) is ≤225° C., in particular≤200° C., as determined according to ISO 11357-3: 2013, at a heating rate of 20 K/min.

In one embodiment, said composition of layer (1) is free of plasticizer and/or impact modifier.

In another embodiment, said composition of the layer (1) comprises at least one compound chosen from a plasticizer, an impact modifier and an additive, and said recycled material is chosen from a ground tube.

Advantageously, in these last two embodiments, said tube is a single-layer tube and/or a multilayer tube.

In one embodiment, the fluid transported by said single-layer and/or multilayer tube or stored in said tank is different from that of said multilayer tubular structure (MLT).

This means that if the single-layer and/or multilayer tube has transported a fluid such as air, said multilayer tubular structure (MLT) may be intended to transport gasoline, or even, that if the single-layer and/or multilayer tube has transported a fluid such as alcohol-blended gasoline, said multilayer tubular structure (MLT) may be intended to transport diesel. The same goes for the tank.

In another embodiment, the fluid transported by said single-layer and/or multilayer tube or stored in said tank is the same as that of said multilayer tubular structure (MLT).

This means that if the single-layer and/or multilayer tube has transported a fluid such as gasoline, said tubular structure (MLT) may be intended to transport gasoline provided that the gasoline of the single-layer and/or multilayer tube and of said multilayer tubular structure (MLT) is the same, for example, alcohol-blended gasoline.

The same goes for the tank.

Advantageously, the recycled material comes from a single-layer tube consisting of a composition comprising only a PA11.

Needless to say, said PA11 may be formulated.

In one embodiment, said composition of the layer (1) comprises at least 60% by weight, notably at least 70% by weight, notably at least 80% by weight, in particular at least 90% by weight, more particularly at least 95% by weight of recycled material without, however, exceeding 99.8%.

The recycled material may be mixed with virgin polyamide with additives or with a master batch with a large amount of additives.

### Recycled Used Single-Layer or Multilayer Tube or Tank

Said used tube or tank which was intended for transporting or storing motor vehicle fluid is ground with extraction of the fluid residues before or after grinding and the composition of the layer (1) resulting from said recycling consists of a composition comprising:
a) at least 50% by weight, in particular from 50% to 99.8% by weight, of at least one semicrystalline aliphatic polyamide noted C having an average number of carbon atoms per nitrogen atom noted C_{C} of from 6 to 18, advantageously from 8 to 12;
b1) from 0 to 25% by weight of at least one semicrystalline aliphatic polyamide noted B and having an average number of carbon atoms per nitrogen atom noted C_{B}=C_{C}−1, preferentially C_{B}=C_{C}−2;
b2) from 0 to 25% by weight of a semicrystalline aliphatic polyamide noted A and having an average number of carbon atoms per nitrogen atom noted C_{A}=C_{B}−1, preferentially C_{A}=C_{B}−2;
c) from 0 to 45% by weight of at least one impact modifier, in particular from 1% to 45% by weight of at least one impact modifier, notably from 2% to 45% by weight of at least one impact modifier,
d) from 0 to 20% by weight of at least one plasticizer,
e) from 0 to 0.2% by weight of at least one additive, the sum of the constituents being equal to 100%. Advantageously, the semicrystalline aliphatic polyamide noted C is chosen from PA612, PA1012, PA1010, PA11 and PA12, notably PA11.

Advantageously, it is ground only, excluding grinding followed by recompounding with or without reformulation.

Advantageously, said used tube or said tank was intended for transporting or storing fuel such as gasoline, in particular alcohol-blended gasoline, bio-gasoline or diesel, in particular bio-diesel.

Advantageously, the semicrystalline aliphatic polyamide noted C is chosen from PA612, PA1012, PA1010, PA11 and PA12, in particular PA11 and said tube was intended for transporting fuel such as gasoline, in particular alcohol-blended gasoline, bio-gasoline or diesel, in particular bio-diesel.

Advantageously, said tube or said tank which was intended for transporting or storing motor vehicle fluid is single-layered, advantageously said tube and said tank are in admixture in a range from 5/95 to 95/5 by weight.

In a first variant, said used tube or tank which was intended for the transport or storage of motor vehicle fluid is ground with extractions of fluid residues before or after grinding and the composition of the layer (1) resulting from said recycling consists of a composition as defined for the first variant and the embodiments associated therewith described in the section “As regards layer (1)” above.

In a second variant, said used tube or tank which was intended for transporting or storing motor vehicle fluid is ground with extraction of fluid residues before or after grinding and the composition of the layer (1) resulting from said recycling consists of a composition as defined for the second variant and the embodiments associated therewith described in the section “As regards layer (1)” above.

### As Regards Layer (2)

In one embodiment, the structure is multilayered and comprises at least one layer (2).

In one embodiment, the multilayer tubular structure comprises at least one layer (2) consisting of a composition predominantly comprising at least one semicrystalline, semiaromatic aliphatic polyamide or a polyolefin.

Advantageously, said layer (2) consists of at least 90% non-recycled material.

The terms “semicrystalline polyamide” and “aliphatic” have the same definition as for layer (1).

Said at least one semicrystalline aliphatic polyamide is obtained in the same manner as described above for layer (1).

The semiaromatic polyamide is as defined below.

The polyolefin is as defined below for the impact modifier polyolefin.

In a first variant, said layer (2) consists of a composition predominantly comprising at least one semicrystalline aliphatic polyamide and optionally at least one impact modifier,
and when the layer (2) consists of a composition predominantly comprising at least one semicrystalline aliphatic polyamide which is PA12 and/or PA610 and/or PA612 and/or PA1010 and/or PA6, then said composition comprises said impact modifier, and said layer (2) consists of at least 90% non-recycled material.

In one embodiment of this first variant, said layer (2) is free of impact modifier.

In this case, the semicrystalline aliphatic polyamide, which is PA12 and/or PA610 and/or PA612 and/or PA1010 and/or PA6, is excluded from the composition constituting the layer (2).

In another embodiment of this first variant of the layer (2), said layer (2) comprises c) from 3% to 45% by weight of at least one impact modifier, in particular from 5% to 20% by weight of at least one impact modifier.

In yet another embodiment of this first variant, said layer (2) consists of a composition comprising:
a) at least 50% by weight, notably from 50% to 99.8% by weight, of at least one semicrystalline aliphatic polyamide noted D and having an average number of carbon atoms per nitrogen atom noted CD of from 6 to 18, advantageously from 9 to 15;
b1) from 0 to 25% by weight of at least one semicrystalline aliphatic polyamide noted E and having an average number of carbon atoms per nitrogen atom noted CE=CD−1, preferentially CE=CD−2;
b2) from 0 to 25% by weight of a semicrystalline aliphatic polyamide noted F and having an average number of carbon atoms per nitrogen atom noted CF=CE−1, preferentially CF=CE−2;
c) from 3% to 45% by weight of at least one impact modifier, in particular from 5% to 20% by weight of at least one impact modifier;
d) from 0 to 20% of at least one plasticizer;
e) from 0 to 0.2% by weight of at least one additive;
f) from 0 to 35% by weight of at least one antistatic filler;
the sum of the constituents a), b1), b2), c), d), e), f) being equal to 100%.

Advantageously, in this first variant, said composition of the layer (2) comprises: b1) from 1% to 50% by weight of at least one semicrystalline aliphatic polyamide noted E and having an average number of carbon atoms per nitrogen atom noted CE=CD−1, preferentially CE=CD−2.

Advantageously, in this first variant, said composition of the layer (2) comprises: b2) from 1% to 50% by weight of a semicrystalline aliphatic polyamide noted F and having an average number of carbon atoms per nitrogen atom noted CF=CE−1, preferentially CF=CE−2.

Advantageously, in this first variant, said composition of the layer (2) comprises: b1) from 1% to 50% by weight of at least one semicrystalline aliphatic polyamide noted E and having an average number of carbon atoms per nitrogen atom noted CE=CD−1, preferentially CE=CD−2 and b2) from 1% to 50% by weight of a semicrystalline aliphatic polyamide noted F and having an average number of carbon atoms per nitrogen atom noted CF=CE−1, preferentially CF=CE−2.

Advantageously, in this first variant, said composition of the layer (2) comprises: d) from 1% to 20% by weight of at least one plasticizer.

Advantageously, in this first variant, said composition of the layer (2) comprises: e) from 1% to 0.2% by weight of at least one additive.

Advantageously, in this first variant, said composition of the layer (2) comprises: f) from 1% to 35% by weight of at least one antistatic filler.

All the combinations between a), b1), b2), c), d), e) and f) defined above are possible in this first variant.

In a second variant, said layer (2) consists of a composition consisting of:
a) at least 50% by weight, notably from 50% to 99.8% by weight, of at least one semicrystalline aliphatic polyamide noted D and having an average number of carbon atoms per nitrogen atom noted CD of from 6 to 18, advantageously from 9 to 15;
b1) from 0 to 25% by weight of at least one semicrystalline aliphatic polyamide noted E and having an average number of carbon atoms per nitrogen atom noted CE=CD−1, preferentially CE=CD−2;
b2) from 0 to 25% by weight of a semicrystalline aliphatic polyamide noted F and having an average number of carbon atoms per nitrogen atom noted CF=CE−1, preferentially CF=CE−2;
c) from 3% to 45% by weight of at least one impact modifier, in particular from 5% to 20% by weight of at least one impact modifier;
d) from 0 to 20% of at least one plasticizer;
e) from 0 to 0.2% by weight of at least one additive,
f) from 0 to 35% by weight of at least one antistatic filler;
the sum of the constituents a), b1), b2), c), d), e) and f) being equal to 100%.

All the embodiments described for the first variant are also valid for this second variant.

Advantageously, the composition of said layer (2) of the first and second variant comprises a PA11, a PA12 or a PA612 and from 3% to 45% by weight of an impact modifier, in particular from 5% to 20% by weight of an impact modifier.

In a third variant, said layer (2) consists of a composition predominantly comprising at least one semiaromatic polyamide.

In a fourth variant, said layer (2) consists of a composition predominantly comprising at least one semiaromatic polyamide.

Advantageously, said layer (2) consists of a composition consisting of at least one semiaromatic polyamide.

In a fifth variant, said layer (2) consists of a composition predominantly comprising at least one polyolefin.

In a sixth variant, said layer (2) consists of a composition predominantly comprising at least one polyolefin.

Advantageously, said layer (2) consists of a composition consisting of at least one polyolefin.

### As Regards Layer (2′)

In one embodiment, the multilayer tubular structure comprises at least one layer (2′) consisting of a composition predominantly comprising at least one semicrystalline aliphatic polyamide, semiaromatic polyamide or polyolefin, said layer (2′) consisting of at least 90% non-recycled material.

The terms “semicrystalline polyamide” and “aliphatic” have the same definition as for layer (1) or layer (2).

Said at least one semicrystalline aliphatic polyamide is obtained in the same manner as described above for layer (1) and layer (2). In a first variant of layer (2′), said layer (2′) is free of impact modifiers.

In a second variant of the layer (2′), said layer (2′) comprises from 3% to 45% by weight of at least one impact modifier, in particular from 5% to 20% by weight of at least one impact modifier.

In one embodiment of this second variant, said layer (2′) consists of a composition comprising:
a) at least 50% by weight, notably from 50% to 97% by weight, in particular from 50% to 95% by weight, of at least one semicrystalline aliphatic polyamide noted D and having an average number of carbon atoms per nitrogen atom noted CD of from 6 to 18, advantageously from 9 to 15;
b1) from 0 to 25% by weight of at least one semicrystalline aliphatic polyamide noted E and having an average number of carbon atoms per nitrogen atom noted CE=CD−1, preferentially CE=CD−2;
b2) from 0 to 25% by weight of a semicrystalline aliphatic polyamide noted F and having an average number of carbon atoms per nitrogen atom noted CF=CE−1, preferentially CF=CE−2;
c) from 3% to 45% by weight of at least one impact modifier, in particular from 5% to 20% by weight of at least one impact modifier;
d) from 0 to 20% of at least one plasticizer;
e) from 0 to 2% by weight of at least one additive,
f) from 0 to 35% by weight of at least one antistatic filler;
the sum of the constituents a), b1), b2), c), d), e) and f) being equal to 100%.

Advantageously, in this last embodiment of this second variant, said composition of the layer (2′) comprises: b1) from 1% to 50% by weight of at least one semicrystalline aliphatic polyamide noted E and having an average number of carbon atoms per nitrogen atom noted CE=CD−1, preferentially CE=CD−2.

Advantageously, in this last embodiment of this second variant, said composition of the layer (2′) comprises: b2) from 1% to 50% by weight of a semicrystalline aliphatic polyamide noted F and having an average number of carbon atoms per nitrogen atom noted CF=CE−1, preferentially CF=CE−2.

Advantageously, in this last embodiment of this second variant, said composition of the layer (2′) comprises: b1) from 1% to 50% by weight of at least one semicrystalline aliphatic polyamide noted E and having an average number of carbon atoms per nitrogen atom noted CE=CD−1, preferentially CE=CD−2 and b2) from 1% to 50% by weight of a semicrystalline aliphatic polyamide noted F and having an average number of carbon atoms per nitrogen atom noted CF=CE−1, preferentially CF=CE−2.

Advantageously, in this last embodiment of this second variant, said composition of the layer (2′) comprises: d) from 1% to 20% by weight of at least one plasticizer.

Advantageously, in this last embodiment of this second variant, said composition of the layer (2′) comprises: e) from 1% to 0.2% by weight of at least one additive.

Advantageously, in this last embodiment of this second variant, said composition of the layer (2′) comprises: f) from 1% to 35% by weight of at least one antistatic filler.

All the combinations between a), b1), b2), c), d), e) and f) defined above are possible in this last embodiment of this second variant.

In another embodiment of this second variant, said layer (2′) consists of a composition consisting of:
a) at least 50% by weight, notably from 50% to 97% by weight, in particular from 50% to 95% by weight, of at least one semicrystalline aliphatic polyamide noted D and having an average number of carbon atoms per nitrogen atom noted CD of from 6 to 18, advantageously from 9 to 15;
b1) from 0 to 25% by weight of at least one semicrystalline aliphatic polyamide noted E and having an average number of carbon atoms per nitrogen atom noted CE=CD−1, preferentially CE=CD−2;
b2) from 0 to 25% by weight of a semicrystalline aliphatic polyamide noted F and having an average number of carbon atoms per nitrogen atom noted CF=CE−1, preferentially CF=CE−2;
c) from 3% to 45% by weight of at least one impact modifier, in particular from 5% to 20% by weight of at least one impact modifier;
d) from 0 to 20% of at least one plasticizer;
e) from 0 to 2% by weight of at least one additive,
f) from 0 to 35% by weight of at least one antistatic filler;
the sum of the constituents a), b1), b2), c), d), e) and f) being equal to 100%.

All the embodiments described previously in the last embodiment of this second variant are also valid for this other embodiment of this second variant.

Advantageously, the composition of said layer (2′) comprises a PA11, a PA12 or a PA612 and from 3% to 45% by weight of at least one impact modifier, in particular from 5% to 20% by weight of at least one impact modifier.

In a third variant, said layer (2′) consists of a composition predominantly comprising at least one semiaromatic polyamide.

Said at least one semiaromatic semicrystalline polyamide is obtained from the polycondensation of at least one diamine X as defined above, with at least one aromatic dicarboxylic acid or a diamine Xa with a dicarboxylic acid Y as defined above.

The aromatic dicarboxylic acid is advantageously chosen from terephthalic acid (noted T), isophthalic acid (noted I) and 2,6-naphthalenedicarboxylic acid (noted N) or mixtures thereof; in particular, it is chosen from terephthalic acid (noted T), isophthalic acid (noted I) or mixtures thereof.

The diamine Xa is advantageously an arylamine, which may be chosen from meta-xylylenediamine (MXD, CAS No. 1477-55-0) or para-xylylenediamine (PXD, CAS No: 539-48-0).

When said semiaromatic semicrystalline polyamide is obtained from the polycondensation of at least one diamine X with at least one aromatic dicarboxylic acid, or of at least one diamine Xa with at least one dicarboxylic acid Y, it may thus comprise a single diamine or several diamines and a single dicarboxylic acid or several dicarboxylic acids.

Advantageously, said semicrystalline semiaromatic polyamide is obtained from the polycondensation of a single diamine X with a single aromatic dicarboxylic acid or from the polycondensation of a single diamine Xa with a single dicarboxylic acid Y.

Advantageously, said semicrystalline semiaromatic polyamide is obtained from the polycondensation of at least one diamine X with at least one dicarboxylic acid chosen from terephthalic acid and isophthalic acid, notably terephthalic acid, or said semicrystalline semiaromatic polyamide is obtained from the polycondensation of at least one diamine Xa with at least one dicarboxylic acid Y.

In particular, said at least one C6 to C12 diamine X is chosen from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine and said at least one dicarboxylic acid is an acid chosen from terephthalic acid and isophthalic acid, notably terephthalic acid.

In particular, said at least one diamine Xa is an arylamine chosen from meta-xylylenediamine (MXD, CAS No.: 1477-55-0) or para-xylylenediamine (PXD, CAS No.: 539-48-0) and said at least one dicarboxylic acid Y is C6-C18 and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

Advantageously, said at least one dicarboxylic acid Y is C6-C12 and is chosen from adipic acid, suberic acid, azelaic acid, sebacic acid, undecanedioic acid and dodecanedioic acid.

Each of these semiaromatic polyamides may be copolymerized with a lactam or an amino acid to give structures such as PA10/10T, PA10/9T, PA 10/12T, PA11/9T, PA11/10T, PA11/12T, PA12/9T, PA12/10T and PA12/12T or PA11/MXD6, PA11/MXD10, PA12/MXD6, PA12/MXD10.

In a fourth variant, said layer (2′) consists of a composition predominantly comprising at least one polyolefin.

### As Regards the Impact Modifier and the Polyolefin

The impact modifier advantageously consists of a polymer with a flexural modulus of less than 100 MPa measured according to the standard ISO 178: 2010, determined at 23° C. with a relative humidity: RH of 50%, and a Tg below 0° C. (measured according to the standard 11357-2:2013 at the inflection point of the DSC thermogram, at a heating rate of 20 K/min), in particular a polyolefin.

The polyolefin of the impact modifier may be functionalized or non-functionalized or be a mixture of at least one which is functionalized and/or of at least one which is non-functionalized. To simplify, the polyolefin has been denoted (B) and functionalized polyolefins (B1) and non-functionalized polyolefins (B2) have been described below.

A non-functionalized polyolefin (B2) is conventionally a homopolymer or copolymer of alpha-olefins or diolefins, for instance ethylene, propylene, 1-butene, 1-octene or butadiene. Examples that may be mentioned include:
polyethylene homopolymers and copolymers, in particular LDPE, HDPE, LLDPE (linear low density polyethylene), VLDPE (very low density polyethylene) and metallocene polyethylene,
propylene homopolymers or copolymers,
ethylene/alpha-olefin such as ethylene/propylene, EPR (abbreviation for ethylene-propylene-rubber) and ethylene/propylene/diene (EPDM) copolymers.
styrene/ethylene-butene/styrene (SEBS), styrene/butadiene/styrene (SBS), styrene/isoprene/styrene (SIS) and styrene/ethylene-propylene/styrene (SEPS) block copolymers.
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to be up to 40% by weight.

The functionalized polyolefin (B1) may be a polymer of α-olefins bearing reactive units (the functionalities); such reactive units are acid, anhydride or epoxy functions. By way of example, mention may be made of the preceding polyolefins (B2) grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized with metals such as Zn, and the like), or else with carboxylic acid anhydrides, such as maleic anhydride. A functionalized polyolefin is, for example, a PE/EPR mixture, the weight ratio of which can vary within broad limits, for example between 40/60 and 90/10, said mixture being cografted with an anhydride, notably maleic anhydride, in a degree of grafting of, for example, from 0.01% to 5% by weight.

The functionalized polyolefin (B1) may be chosen from the following (co)polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/alpha-olefin such as ethylene/propylene, EPR (abbreviation for ethylene-propylene-rubber) and ethylene/propylene/diene (EPDM) copolymers.
styrene/ethylene-butene/styrene (SEBS), styrene/butadiene/styrene (SBS), styrene/isoprene/styrene (SIS) and styrene/ethylene-propylene/styrene (SEPS) block copolymers.
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (B1) may also be chosen from ethylene/propylene copolymers, predominant in propylene, grafted with maleic anhydride and then condensed with monoaminated polyamide (or polyamide oligomer) (products described in EP-A-0342066).

The functionalized polyolefin (B1) may also be a copolymer or terpolymer of at least the following units: (1) ethylene, (2) alkyl (meth)acrylate or saturated carboxylic acid vinyl ester and (3) anhydride, such as maleic or (meth)acrylic acid anhydride, or epoxy, such as glycidyl (meth)acrylate.

As examples of functionalized polyolefins of the latter type, mention may be made of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be salified with Zn or Li.

The term “alkyl (meth)acrylate” in (B1) or (B2) denotes C1-C8 alkyl methacrylates and acrylates and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) may also be crosslinked via any suitable process or agent (diepoxy, diacid, peroxide, etc.); the term “functionalized polyolefin” also includes mixtures of the abovementioned polyolefins with a bifunctional reagent such as diacid, dianhydride, diepoxy, etc. that is capable of reacting with these polyolefins or mixtures of at least two functionalized polyolefins which may react together.

The abovementioned copolymers, (B1) and (B2), can be copolymerized in random or block fashion and may have a linear or branched structure.

The molecular weight, the MFI index and the density of these polyolefins may also vary within a broad range, which will be perceived by a person skilled in the art. MFI is the abbreviation for the Melt Flow Index. It is measured according to the standard ASTM 1238.

The non-functionalized polyolefins (B2) are advantageously chosen from polypropylene homopolymers or copolymers, and any ethylene homopolymer, or copolymer of ethylene and a comonomer of higher alpha-olefin type, such as butene, hexene, octene, or 4-methyl-1-pentene. Mention may be made, for example, of PPs, high density PEs, medium density PEs, linear low density PEs, low density PEs or ultra low density PEs. These polyethylenes are known by a person skilled in the art to be produced according to a “free radical” process, according to a “Ziegler” type catalysis or, more recently, according to a “metallocene” catalysis.

The functionalized polyolefins (B1) are advantageously chosen from any polymer comprising α-olefin units and units bearing polar reactive functions, such as epoxy, carboxylic acid or carboxylic acid anhydride functions. Examples of such polymers that may be mentioned include terpolymers of ethylene, of alkyl acrylate and of maleic anhydride or of glycidyl methacrylate, such as the Lotader® products from the Applicant, or polyolefins grafted with maleic anhydride, such as the Orevac® products from the Applicant, and also terpolymers of ethylene, of alkyl acrylate and of (meth)acrylic acid. Mention may also be made of polypropylene homopolymers or copolymers grafted with a carboxylic acid anhydride and then condensed with polyamides or monoaminated oligomers of polyamide.

### As Regards the Additives

The additives optionally used in the compositions of the invention are the conventional additives used in polyamides, well known to those skilled in the art and notably described in EP 2098580.

For example, they are chosen from catalysts, antioxidants, heat stabilizers, UV absorbers, light stabilizers, lubricants, inorganic fillers, flame retardants, nucleating agents, colorants, reinforcing fibers, waxes and mixtures thereof.

The term “catalyst” denotes a polycondensation catalyst such as a mineral or organic acid.

Advantageously, the weight proportion of catalyst is from about 50 ppm to about 5000 ppm, in particular from about 100 to about 3000 ppm, relative to the total weight of the composition.

Advantageously, the catalyst is chosen from phosphoric acid (H3PO4), phosphorous acid (H3PO3) and hypophosphorous acid (H3PO2), or a mixture thereof.

By way of example, the stabilizer may be a UV stabilizer, an organic stabilizer or more generally a combination of organic stabilizers, such as an antioxidant of phenol type (for example of the type such as Irganox® 245 or 1098 or 1010 from the company Ciba-BASF), an antioxidant of phosphite type (for example Irgafos® 126 and Irgafos® 168 from the company Ciba-BASF) and even optionally other stabilizers, such as a HALS, which means Hindered-Amine Light Stabilizer (for example Tinuvin® 770 from the company Ciba-BASF), a UV absorber (for example Tinuvin® 312 from the company Ciba), or a phosphorus-based stabilizer. Use may also be made of antioxidants of amine type, such as Naugard® 445 from the company Crompton or else polyfunctional stabilizers, such as Nylostab® S-EED from the company Clariant.

This stabilizer may also be a mineral stabilizer, such as a copper-based stabilizer. Examples of such mineral stabilizers that may be mentioned include copper acetates and halides. Incidentally, other metals, such as silver, may possibly be considered, but said metals are known to be less effective. These copper-based compounds are typically combined with halides of alkali metals, in particular potassium.

### As Regards the Plasticizer

By way of example, the plasticizers are chosen from benzenesulfonamide derivatives, such as n-butylbenzenesulfonamide (BBSA); ethyltoluenesulfonamide or N-cyclohexyltoluenesulfonamide; hydroxybenzoic acid esters such as 2-ethylhexyl para-hydroxybenzoate and 2-decylhexyl para-hydroxybenzoate; tetrahydrofurfuryl alcohol esters or ethers such as oligoethyleneoxytetrahydrofurfuryl alcohol; and esters of citric acid or of hydroxymalonic acid, such as oligoethyleneoxy malonate.

It would not constitute a departure from the scope of the invention to use a mixture of plasticizers.

When they are present in the composition, the additives are advantageously present from 1% to 20% by weight, notably from 5% to 15% by weight, in particular from 5% to 12% by weight.

### As Regards the Antistatic Fillers

The antistatic fillers are chosen, for example, from carbon black, graphite, carbon fibers and carbon nanotubes, in particular carbon black and carbon nanotubes.

### As Regards the Structure

All the embodiments of layer (1) described above in the section “As regards layer (1)” may be used for the structure detailed in this section.

In one embodiment, said layer (1) is located between a layer (2) and a layer (2′).

Advantageously, said layer (2′) is the layer in contact with the transported fluid.

Preferably, said layer (2′) is as defined for layer (2), and preferably layers (2) and (2′) are identical.

In one embodiment, layers (2) and (2′) are different, and only layer 2′ may contain antistatic charges.

In the latter embodiment, the fact that said layer (2′) is as defined for layer (2) means that the compositions of layer (2) and layer (2′) may be identical or different.

When they are different, they may differ in terms of the polyamide or the proportion of polyamide, or in terms of one of the other constituents of the composition.

Advantageously, the composition of said layer (2) comprises a PA11, a PA12 or a PA612 and the recycled material comes from a single-layer tube and/or a tank consisting of a composition comprising only a PA11; in particular, the composition of the layer (1) consists of at most 99.8% recycled material.

Advantageously, the composition of said layer (2) comprises a PA11, a PA12 or a PA612, and the recycled material comes from a single-layer tube and/or a tank comprising a composition solely comprising a PA11; in particular, the composition of the layer (1) consists of at most 99.8% recycled material and the composition of said layer (2′) comprises a PA11, a PA12 or a PA612.

Advantageously, the composition of said layer (2) comprises a PA11, a PA12 or a PA612 and from 3% to 45% by weight of at least one impact modifier, in particular from 5% to 20% by weight of at least one impact modifier, and the recycled material comes from a single-layer tube and/or from a tank comprising a composition comprising only a PA11; in particular, the composition of the layer (1) consists of at most 99.8% recycled material.

Advantageously, the composition of said layer (2) comprises a PA11, a PA12 or a PA612 and from 3% to 45% by weight of at least one impact modifier, in particular from 5% to 20% by weight of at least one impact modifier, and the recycled material comes from a single-layer tube and/or a tank consisting of a composition comprising only a PA11; in particular, the composition of the layer (1) consists of at most 99.8% recycled material and the composition of said layer (2′) comprises a PA11, a PA12 or a PA612 and from 3% to 45% by weight of at least one impact modifier, in particular from 5% to 20% by weight of at least one impact modifier.

Advantageously, the compositions of layer (2) and layer (2′) are identical and thus layers (2) and (2′) are of course identical, i.e. both the polyamide and the other constituents of the composition are identical in nature and proportion and the thickness of both layers (2) and (2′) is identical. Layer (2′) is then a layer (2).

In a first variant of the multilayer tubular structure (MLT), it consists of three layers (2)//(1)//(2′).

Advantageously, it consists of three layers (2)//(1)//(2).

In one embodiment, at least one binder layer (3) is present, said layer (3) being located between layer (2) and layer (1) and/or between layer (1) and layer (2′).

In a second variant of the multilayer tubular structure (MLT), it consists of four layers (2)//binder (3)//(1)//(2′), in particular (2)//binder (3)//(1)//(2).

In a third variant of the multilayer tubular structure (MLT), it consists of four layers (2)//(1)//binder (3)//(2′), in particular (2)//(1)//binder (3)//(2).

In a fourth variant of the multilayer tubular structure (MLT), it consists of five layers (2)//binder (3)//(1)//binder (3)//(2′), in particular (2)//binder (3)//(1)//binder (3)//(2).

In this fourth variant, the two binder layers (3) may be identical or different; in particular, they are identical.

In another embodiment, at least one EVOH layer is present, said layer (3) being located between layer (1) and layer (2′).

The multilayer tubular structure (MLT) thus consists of four layers
(2)//(1)//EVOH//(2′), in particular (2)//(1)//EVOH//(2).

In one embodiment, said layer (1) represents at least 10%, in particular at least 30%, notably at least 50% of the total thickness of said multilayer tubular structure (MLT).

Advantageously, said layer (1) represents at least 60%, in particular at least 70% of the total thickness of said multilayer tubular structure (MLT).

In one embodiment of one of the four variants of the multilayer tubular structure (MLT) or of the four-layer structure with EVOH, said composition of said layer (1) is free of polyamides noted A and B and said composition of said layer (2) comprises polyamides chosen from those noted E, F and a mixture thereof.

In another embodiment of one of the four variants of the multilayer tubular structure (MLT) or of the four-layer structure with EVOH, said composition of said layer (1) comprises polyamides chosen from those noted A, B and a mixture thereof, and said composition of said layer (2) is free of polyamides noted E and F.

In yet another embodiment of one of the four variants of the multilayer tubular structure (MLT) or of the four-layer structure with EVOH, said composition of said layer (1) comprises polyamides chosen from those noted A, B and a mixture thereof, and said composition of said layer (2) comprises polyamides chosen from those noted E, F and a mixture thereof.

In yet another embodiment of one of the four variants of the multilayer tubular structure (MLT) or of the four-layer structure with EVOH, said composition of said layer (1) is free of polyamides noted A and B and said composition of said layer (2) is free of polyamides noted E and F.

Advantageously, in these last four embodiments, the layer (1) comes from a single-layer recycled tube or a single-layer recycled tank or a mixture of the two.

Advantageously, in these last four embodiments, the layer (1) comes from a single-layer recycled tube or a single-layer recycled tank or a mixture of the two and only said composition of said layer (1) comprises at least one impact modifier.

Advantageously, in these last four embodiments, the layer (1) comes from a single-layer recycled tube or a single-layer recycled tank or a mixture of the two and said composition of said layer (1) and also said compositions of layer (2) and layer (2′) comprise at least one impact modifier.

Advantageously, in these last four embodiments, the layer (1) comes from a multilayer recycled tube or a multilayer recycled tank or a mixture of the two.

Advantageously, in these last four embodiments, the layer (1) comes from a multilayer recycled tube or a multilayer recycled tank or a mixture of the two and only said composition of said layer (1) comprises at least one impact modifier.

Advantageously, in these last four embodiments, the layer (1) comes from a single-layer recycled tube or a multilayer recycled tank or a mixture of the two.

Advantageously, in these last four embodiments, the layer (1) comes from a multilayer recycled tube or a single-layer recycled tank or a mixture of the two.

Advantageously, in these last four embodiments, the layer (1) comes from a multilayer recycled tube and said composition of said layer (1) and also said compositions of layer (2) and layer (2′) comprise at least one impact modifier.

In one embodiment, said multilayer tubular structure (MLT) is intended for transporting fluids chosen from a fuel such as gasoline, in particular alcohol-blended gasoline, bio-gasoline or diesel, in particular bio-diesel.

### As Regards the Binder

The binder is notably described in patents EP1452307 and EP1162061, EP1216826, EP0428833 and EP3299165.

It is implicit that the layers (2) and (1) or (1) and (2′) adhere together. The layer of binder is intended to be interposed between two layers which do not adhere together, or which adhere together with difficulty.

The binder may be, for example, but without being limited thereto, a composition based on 50% copolyamide 6/12 (ratio 70/30 by mass) of Mn 16 000, and 50% copolyamide 6/12 (ratio 30/70 by mass) of Mn 16 000, a composition based on PP (polypropylene) grafted with maleic anhydride, known under the name Admer QF551A from the company Mitsui, a composition based on PA610 (Mn 30 000, and as defined elsewhere) and 36% PA6 (Mn 28 000) and 1.2% organic stabilizers (consisting of 0.8% phenol Lowinox 44B25 from the company Great Lakes, 0.2% phosphite Irgafos 168 from the company Ciba, 0.2% UV stabilizer Tinuvin 312 from the company Ciba), a composition based on PA612 (Mn 29 000, and as defined elsewhere) and 36% PA6 (Mn 28 000, and as defined elsewhere) and 1.2% organic stabilizers (consisting of 0.8% phenol Lowinox 44B25 from the company Great Lakes, 0.2% phosphite Irgafos 168 from the company Ciba, 0.2% UV stabilizer Tinuvin 312 from the company Ciba), a composition based on PA610 (Mn 30 000, and as defined elsewhere) and 36% PA12 (Mn 35 000, and as defined elsewhere) and 1.2% organic stabilizers (consisting of 0.8% phenol Lowinox 44B25 from the company Great Lakes, 0.2% phosphite Irgafos 168 from the company Ciba, 0.2% UV stabilizer Tinuvin 312 from the company Ciba), a composition based on 40% PA6 (Mn 28 000, and as defined elsewhere), 40% PA12 (Mn 35 000, and as defined elsewhere) and 20% functionalized EPR Exxelor VA1801 (Exxon company) and 1.2% organic stabilizers (consisting of 0.8% phenol Lowinox 44B25 from the company Great Lakes, 0.2% phosphite Irgafos 168 from the company Ciba and 1.2% anti-UV Tinuvin 312 from the company Ciba) or else a composition based on 40% PA6.10 (of Mn 30 000, and as defined elsewhere), 40% PA6 (of Mn 28 000, and as defined elsewhere) and 20% ethylene/ethyl acrylate/anhydride impact modifier in a 68.5/30/1.5 mass ratio (MFI 6 at 190° C. under 2.16 kg), and 1.2% organic stabilizers (consisting of 0.8% phenol Lowinox 44B25 from the company Great Lakes, 0.2% phosphite Irgafos 168 from the company Ciba, and 0.2% UV stabilizer Tinuvin 312 from the company Ciba).

According to another aspect, the present invention relates to a process for preparing a tubular structure as defined above, characterized in that it comprises the extrusion of at least one layer (1) consisting of at least 50% recycled material as defined above, after collecting used pipes from a motor vehicle, in an extruder optionally equipped with a degassing zone.

All the embodiments of layer (1) described above in the section “As regards layer (1)” may be used for the process detailed in this section.

In one embodiment, the used pipes are ground into granules after being collected.

In another embodiment, the fluid residues have been totally or partially extracted from the used pipes before or after grinding.

In yet another embodiment, extraction is performed by means of washing or ventilation.

Advantageously, washing is performed using a solvent, in particular methanol.

Advantageously, ventilation is performed by means of an inertized oven.

In one embodiment, extraction is performed after grinding by means of a degassing zone in said extruder.

Advantageously, the used pipes before or after grinding are cleaned to remove any residual oligomers that may be present in the used pipes.

In one embodiment, said process comprises the following steps:
1) collecting a used single-layer and/or multilayer tube and/or a used tank from a motor vehicle,
2) optionally cleaning the oligomers present,
3) optionally extracting the fluid residues,
4) grinding said tubes and/or said tank,
5) extracting the fluid residues if this has not been done in step 3),
6) extruding said ground tubes and/or tank into a single-layer or multilayer tubular structure.

According to another aspect, the present invention relates to the use of a used single-layer and/or multilayer tube and/or tank which has initially transported or contained motor vehicle fluids, as defined above, for the preparation of a single-layer and/or multilayer tubular structure intended for transporting motor vehicle fluids, in particular air, oil, water, urea solution, a glycol-based coolant, or a fuel such as gasoline, in particular alcohol-blended gasoline, bio-gasoline or diesel, in particular bio-diesel, or hydrogen as defined above, said used single-layer and/or multilayer tube and/or said used tank having been ground into granules and the fluid residues present in said tube and/or tank having been totally or partially extracted, before or after grinding of said tube and/or tank and said tubular structure having during the first storage of gasoline, notably of alcohol-blended gasoline, less than 0.3 g/m² of insoluble extract.

All the embodiments of the layer (1) described above in the section “As regards the layer (1)” may be used for the application detailed in this section.

Advantageously, said used single-layer and/or multilayer tube and/or said used tank are ground into granules, excluding grinding followed by recompounding with or without reformulation.

### BRIEF DESCRIPTION OF THE FIGURES

FIG. 1 shows the Fourier Transform Infrared (FTIR) analysis in Attenuated Total Reflectance (ATR) mode of a ground VHU PA 11 PL gasoline line (continuous gray line), and compared to a PA 11 PL gasoline line 100% based on virgin material (continuous black line).

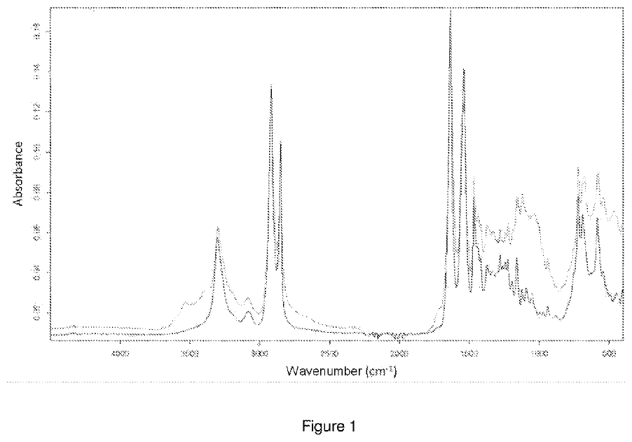

FIG. 2 shows the CH2CO areas of the various secondary amide, primary amide and carboxylic acid functions in 13C NMR in a solvent mixture with an HFIP/CD2CI2 ratio of ⅓.

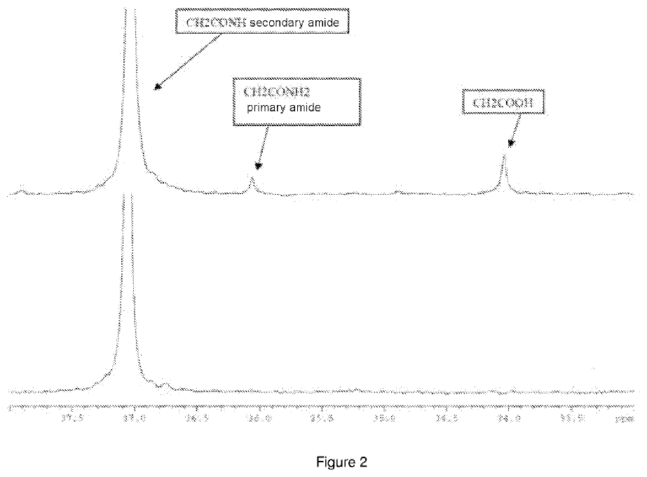

Top spectrum; PA 11 PL ground ELV gasoline line and bottom spectrum: PA 11 PL gasoline line 100% based on virgin material.

### EXAMPLES

### Compositions of the Invention

### Single-Layer Tubes of the Invention:

The tubes are 8×1 mm in size.

Preparation of the single-layer structures (tubes):

The single-layer structures are produced by extrusion. A Maillefer industrial extrusion line is used.

This line comprises a single-screw extruder equipped with a screw profile suitable for polyamides. In addition, the extrusion line includes:
a die-punch assembly, located at the end of the extrusion head; the inside diameter of the die and the outside diameter of the punch are chosen as a function of the structure to be made and of the materials of which it is composed, and also as a function of dimensions of the tube and of the line speed;
a vacuum tank with an adjustable level of vacuum. In this tank circulates water maintained in general at 20° C., into the façade of which is inserted a gauge for conforming the tube to its final dimensions. The diameter of the gauge is adapted to the dimensions of the tube to be made, typically from 8.1 to 10 mm for a tube with an outside diameter of 8 mm and a thickness of 1 mm;
a cooling tank in which water is maintained at about 20° C., for cooling the tube along the path from the head to the drawing bench;
a diameter measurer;
a drawing bench.

Before the tests, in order to ensure the best properties for the tube and a good extrusion quality, it is verified that the extruded materials have a residual moisture content before extrusion of less than 0.08%. If this is not the case, an additional step of drying the material before the tests is performed, generally in a vacuum dryer, overnight at 80° C.

The tubes, which meet the characteristics described in the present patent application, were taken, after stabilization of the extrusion parameters, the target dimensions of the tubes no longer changing over time. The diameter is monitored by a laser diameter measurer installed at the end of the line.

The line speed is typically 20 m/min. It generally varies between 5 and 100 m/min.

The speed of the extruder screws depends on the thickness and diameter of the tube, as is known to those skilled in the art.

In general, the temperature of the extruders and tools (head and joint) should be set so as to be sufficiently higher than the melting point of the compositions under consideration, such that they remain in the molten state, thus preventing them from solidifying and blocking the machine.

The single-layer tubes produced by extrusion above were then evaluated on several criteria:
Aging: This is the durability; in other words, it denotes the resistance of the tube to oxidative aging in hot air. The tube is aged in air at 150° C., and then shocked according to the standard DIN 73378, which is produced at −40° C. The half-life (in hours) is indicated, corresponding to the time after which 50% of the tubes tested break. A qualitative commentary accompanies this value.
A “++” rating is given for durability that may be described as “very good”, corresponding to ≥200h half-life.
A “+” rating is given for durability (resistance to thermo-oxidative aging) that may be described as “good”, corresponding to >100h half-life (and <200h).
A “+-” rating is given for durability (resistance to thermo-oxidative aging) that may be described as “acceptable”, corresponding to ≥50h half-life (and <100h).
A “−” rating is given for durability (resistance to thermo-oxidative aging), which may be described as “poor”, corresponding to <50h.

In cases where a half-life figure is given to show nuances, this figure is rounded off to 25h, to take account of significant figures, linked to the precision of the evaluation.

Use as is: geometry, mechanical behavior and pollution characteristics suitable for installation on new vehicles.
+: use as is is possible.
−: use as is is impossible.

Oligomers (insoluble extractables): this test consists in filling a tube with FAM B-type alcohol-blended gasoline at 60° C. for 96 hours, then emptying and filtering it into a beaker. The filter and the residue are dried until a constant mass is obtained, which must be less than or equal to 0.3 g/m² (tube internal surface area).

TABLE 1

| | | | | Oligomers |
|---|---|---|---|---|
| | Structure (mixture weight %) | | | (insoluble |
| | thickness distribution of the layers | | Use | extractables) |
| Example | (as a percentage of the total thickness) | Aging | as is | (g/m²) |
| CE1 | Virgin single-layer gasoline line | + | + | >0.3 |
| CE2 | ELV single-layer gasoline line | − | − | <0.3 |
| CE3 | Virgin single-layer air transport line | + | + | >0.3 |
| CE4 | ELV single-layer air transport line | − | − | >0.3 |
| CE5 | Virgin three-layer gasoline line | + | + | >0.3 |
| CE6 | ELV three-layer gasoline line | − | − | <0.3 |
| EI1 | Ground ELV single-layer PA 11 PL gasoline | +− | + | <0.3 |
| | line + ground ELV PA11 PL tank + PA 11 PL | | | |
| | Mixture: (35/35/30)% | | | |
| EI2 | Ground ELV single-layer PA11PL gasoline | + | + | <0.3 |
| | line + PA11PL | | | |
| | Mixture: (50/50)% | | | |
| EI3 | PA11NX2//ground ELV three-layer gasoline | + | + | <0.3 |
| | line//PA11NX2 | | | |
| | Thickness distribution: 15/70/15% | | | |
| EI4 | PA11NX2//ground ELV three-layer gasoline | + | + | <0.3 |
| | line + PA610PL (mixture: | | | |
| | (50/50)%)//PA11NX2 | | | |
| | Thickness distribution: 15/70/15% | | | |
| EI5 | PA11NX2//ground ELV PA11PL gasoline | + | + | <0.3 |
| | line + ground ELV PA11PL tank (mixture: | | | |
| | (50/50)%)//PA11NX2 | | | |
| | Thickness distribution: 15/70/15% | | | |
| EI6 | Ground ELV single-layer PA11PL air transport | + | + | NT |
| | line + PA11PL (mixture: (50/50)%) | | | |
| EI7 | Ground ELV single-layer PA12PL air transport | + | + | NT |
| | line + PA12PL (mixture: (50/50)%) | | | |
| EI8 | Ground ELV single-layer PA610PL air | + | + | NT |
| | transport line + PA610PL (mixture: (50/50)%) | | | |
| EI9 | Ground ELV single-layer PA612PL air | + | + | NT |
| | transport line + PA612PL (mixture: (50/50)%) | | | |
| EI10 | Ground ELV single-layer PA 12 PL gasoline | + | + | NT |
| | line + ground ELV PA12 PL tank + PA 12 PL | | | |
| | Mixture: (35/35/30)% | | | |
| EI11 | Ground ELV single-layer PA 610 PL gasoline | + | + | NT |
| | line + ground ELV PA610 PL tank + PA 610 PL | | | |
| | Mixture: (35/35/30)% | | | |
| EI12 | Ground ELV single-layer PA 612 PL gasoline | + | + | NT |
| | line + ground ELV PA 612 PL tank + PA 612 PL | | | |
| | Mixture: (35/35/30)% | | | |
| EI13 | PA11/10TPL//ground ELV three-layer | + | + | NT |
| | gasoline line + PA610PL (mixture: | | | |
| | (50/50)%)//PA11/10TPL | | | |
| | Thickness distribution: 15/70/15% | | | |

CE1 to CE6: counter-examples
EI1 to EI13: Examples of the invention
NT: not tested

The following compositions were compounded on a Coperion/Werner 40 mm twin-screw extruder, 70 kgh, 300 rpm, 270° C. set point, with −100 mmHg degassing.
“PA11PL” is a virgin PA 11 containing 7% BBSA and 1% stabilizer.
“PA11NX2” is a virgin PA11 containing 10% PA610, 5% maleic anhydride functionalized EPR impact modifier and 1% stabilizer.
“PA12PL” is a virgin PA 12 containing 7% BBSA and 1% stabilizer.
“PA11/10TPL” is a virgin PA 11/10T (0.7/0.3) containing 7% BBSA and 1% stabilizer.
“PA610PL” is a virgin PA610 containing 7% BBSA and 1% stabilizer.
“PA612PL” is a virgin PA612 containing 7% BBSA and 1% stabilizer.

The following compositions are ground materials from tubes and tanks collected from ELVs in a scrapyard.
“ground ELV PA 11 PL gasoline line” are chips of gasoline lines collected from ELVs with a mole ratio of primary amide functions relative to the secondary amide functions of 0.02, a mole ratio of nitrile functions of 0.05, and a mole ratio of methyl functions of 0.004.
“ground ELV PA 12 PL gasoline line” are chips of gasoline lines collected from ELVs with a mole ratio of primary amide functions relative to the secondary amide functions of 0.02, a mole ratio of nitrile functions of 0.05, and a mole ratio of methyl functions of 0.004.
“ground ELV PA11 PL tank” are chips of gasoline tanks collected from ELVs with a mole ratio of primary amide functions relative to the secondary amide functions of 0.01, a mole ratio of nitrile functions of 0.02, a mole ratio of methyl functions of 0.002.
“ground ELV PA12 PL tank” are chips of gasoline tanks collected from ELVs with a mole ratio of primary amide functions relative to the secondary amide functions of 0.01, a mole ratio of nitrile functions of 0.02, a mole ratio of methyl functions of 0.002.
“ground ELV PA11PL air transport line” are chips of brake pipes collected from ELVs with a mole ratio of primary amide functions relative to the secondary amide functions of 0.04, a mole ratio of nitrile functions of 0.1, a mole ratio of methyl functions of 0.01.
“ground ELV PA12PL air transport line” are chips of brake pipes collected from ELVs with a mole ratio of primary amide functions relative to the secondary amide functions of 0.03, a mole ratio of nitrile functions of 0.09, a mole ratio of methyl functions of 0.008.
“ground ELV PA610PL air transport line” are chips of brake pipes collected from ELVs with a mole ratio of primary amide functions relative to the secondary amide functions of 0.02, a mole ratio of nitrile functions of 0.07, a mole ratio of methyl functions of 0.010.
“ground ELV PA612PL air transport line” are chips of brake pipes collected from ELVs with a mole ratio of primary amide functions relative to the secondary amide functions of 0.03, a mole ratio of nitrile functions of 0.08, a mole ratio of methyl functions of 0.009.
“ground ELV PA610PL gasoline line” are chips of gasoline lines collected from ELVs with a mole ratio of primary amide functions relative to the secondary amide functions of 0.01, a mole ratio of nitrile functions of 0.03 and a mole ratio of methyl functions of 0.001.
“ground ELV PA612PL gasoline line” are chips of gasoline lines collected from ELVs with a mole ratio of primary amide functions relative to the secondary amide functions of 0.01, a mole ratio of nitrile functions of 0.04, a mole ratio of methyl functions of 0.002.
“ground ELV PA610 PL tank” are chips of gasoline tanks collected from ELVs with a mole ratio of primary amide functions relative to the secondary amide functions of 0.009, a mole ratio of nitrile functions of 0.01, a mole ratio of methyl functions of 0.001.
“ground ELV PA612 PL tank” are chips of gasoline tanks collected from ELVs with a mole ratio of primary amide functions relative to the secondary amide functions of 0.008, a mole ratio of nitrile functions of 0.02, a mole ratio of methyl functions of 0.001.

The mole ratio is determined as defined in the above text.

### Multilayer Tubes of the Invention:

The layers are described from outside to inside, followed by their respective thicknesses indicated as a percentage; the tubes are 8×1 mm in size.

### Preparation of the Multilayer Structures (Tubes):

The multilayer tubes are produced by coextrusion. A Maillefer multilayer extrusion industrial line is used, equipped with five extruders connected to a multilayer extrusion head with spiral mandrels.

The screws used are single extrusion screws having screw profiles adapted to the polyamides. In addition to the five extruders and the multilayer extrusion head, the extrusion line includes:
a die-punch assembly, located at the end of the coextrusion head; the inside diameter of the die and the outside diameter of the punch are chosen as a function of the structure to be made and of the materials of which it is composed, and also as a function of dimensions of the tube and of the line speed;
a vacuum tank with an adjustable level of vacuum. In this tank circulates water maintained in general at 20° C., into which is immersed a gauge for conforming the tube to its final dimensions. The diameter of the gauge is adapted to the dimensions of the tube to be made, typically from 8.5 to 10 mm for a tube with an outside diameter of 8 mm and a thickness of 1 mm;
a succession of cooling tanks in which water is maintained at about 20° C., for cooling the tube along the path from the head to the drawing bench;
a diameter measurer;
a drawing bench.

The configuration with five extruders is used to make tubes ranging from 2 layers to 5 layers (and also single-layer tubes). In the case of the structures in which the number of layers is less than 5, several extruders are then fed with the same material.

Before the tests, in order to ensure the best properties for the tube and a good extrusion quality, it is verified that the extruded materials have a residual moisture content before extrusion of less than 0.08%. If this is not the case, an additional step of drying the material before the tests is carried out, generally in a vacuum dryer, overnight at 80° C.

The tubes, which meet the characteristics described in the present patent application, were taken, after stabilization of the extrusion parameters, the target dimensions of the tubes no longer changing over time. The diameter is monitored by a laser diameter measurer installed at the end of the line.

The line speed is typically 20 m/min. It generally varies between 5 and 100 m/min.

The speed of the extruder screws depends on the thickness of the layer and on the diameter of the screw, as is known to those skilled in the art.

In general, the temperatures of the extruders and tools (head and joint) should be set so as to be sufficiently higher than the melting point of the compositions under consideration, such that they remain in the molten state, thus preventing them from solidifying and blocking the machine.
“Virgin single-layer gasoline line” is an 8×1 mm virgin single-layer gasoline line composed of PA11 PL.
“ELV single-layer gasoline line” is an 8×1 mm single-layer gasoline line composed of PA11 PL collected from an end-of-life motor vehicle (ELV).
“Virgin three-layer gasoline line” is an 8×1 mm virgin three-layer gasoline line, interior>PA11NX2//PA610 PL//PA11NX2<exterior, having the following thickness distributions: 15%/70%/15%.
“ELV three-layer gasoline line” is an ELV 8×1 mm three-layer gasoline line, interior>PA11NX2//PA610 PL//PA11NX2<exterior, having the following thickness distributions: 15%/70%/15%.

1. A composition comprising:
(a) 30% to 99.8% by weight of recycled material from a used single-layer and/or multilayer tube and/or tank having initially transported or contained motor vehicle fluids, said tube and/or said tank consisting of a composition which predominantly comprises at least one polyamide,
said used single-layer and/or multilayer tube and/or said used tank having been ground into granules and the fluid residues present in said tube and/or tank having been totally or partially extracted, before or after grinding of said tube and/or tank,
(b) up to 70% of a semicrystalline aliphatic polyamide,
(c) up to 45% by weight of at least one impact modifier,
(d) up to 20% by weight of at least one plasticizer,
(e) up to 0.2% of an additive,
said polyamide of said used tube and/or said used tank having functions resulting from oxidation reactions chosen from the primary amide functions, nitriles, terminal methyl groups, alkenes, formamides, imides, carboxylic acids and alcohols and mixtures thereof, in a mole ratio relative to the amide functions greater than that of the same polyamide constituting a non-used tube and/or tank which has not yet transported or contained motor vehicle fluids.

2. The composition as claimed in claim 1, wherein said mole ratio of functions produced by oxidation reactions ranges from 1/10 000 to 1/20.

3. The composition as claimed in claim 1, wherein said mole ratio of imide functions ranges from 1/1000 to 1/20.

4. The composition as claimed in claim 1, wherein said mole ratio of carboxylic acid functions ranges from 1/5000 to 1/20.

5. The composition as claimed in claim 1, wherein said mole ratio of alcohol functions ranges from 1/1000 to 1/20.

6. The composition as claimed in claim 1, wherein said mole ratio of primary amide functions ranges from 1/2000 to 1/20.

7. The composition as claimed in claim 1, wherein said mole ratio of nitrile functions ranges from 1/1000 to 1/20.

8. The composition as claimed in claim 1, wherein said mole ratio of terminal methyl functions ranges from 1/5000 to 1/50.

9. A single-layer or multilayer tubular structure (MLT) intended for transporting motor vehicle fluids comprising at least one layer (1) consisting of a composition as defined in claim 1.

10. The single-layer or multilayer tubular structure (MLT) as claimed in claim 9, wherein it has during the first storage of gasoline a maximum of 0.3 g/m² of insoluble extract.

11. The single-layer or multilayer tubular structure (MLT) as claimed in claim 9, wherein the extraction of said fluid residues is performed by means of washing or ventilation.

12. The single-layer or multilayer tubular structure (MLT) as claimed in claim 9, wherein the structure is multilayered and comprises at least one layer (2).

13. The multilayer tubular structure (MLT) as claimed in claim 12, wherein said layer (2) consists of a composition predominantly comprising at least one semicrystalline aliphatic polyamide and optionally at least one impact modifier,
and when the layer (2) consists of a composition predominantly comprising at least one semicrystalline aliphatic polyamide which is PA12 and/or PA610 and/or PA612 and/or PA1010, then said composition comprises said impact modifier, and said layer (2) consists of at least 90% non-recycled material.

14. The multilayer tubular structure (MLT) as claimed in claim 12, wherein it comprises at least one layer (2′) consisting of a composition predominantly comprising at least one semicrystalline aliphatic polyamide, semiaromatic polyamide or polyolefin, said layer (2′) consisting of at least 90% non-recycled material.

15. The multilayer tubular structure (MLT) as claimed in claim 14, wherein said layer (2′) consists of a composition predominantly comprising at least one semiaromatic polyamide.

16. The multilayer tubular structure (MLT) as claimed in claim 14, wherein said layer (2′) consists of a composition predominantly comprising at least one polyolefin.

17. The multilayer tubular structure (MLT) as claimed in claim 14, wherein said layer (1) is between a layer (2) and a layer (2′).

18. The multilayer tubular structure (MLT) as claimed in claim 14, wherein the layer (2′) is the layer that is in contact with the fluid.

19. The multilayer tubular structure (MLT) as claimed in claim 14, wherein the layer (2′) is as defined for the layer (2).

20. The multilayer tubular structure (MLT) as claimed in one of claim 14, wherein at least one binder layer (3) is present, said layer (3) being located between layer (2) and layer (1) and/or between layer (1) and layer (2′).

21. The single-layer or multilayer tubular structure (MLT) as claimed in claim 9, wherein said layer (1) represents at least 10% of the total thickness of said single-layer or multilayer tubular structure (MLT).

22. The single-layer or multilayer tubular structure (MLT) as claimed in claim 9, wherein said layer (1) consists of a composition comprising:
at least 50% by weight of at least one semicrystalline aliphatic polyamide noted C having an average number of carbon atoms per nitrogen atom noted C_{C} of from 6 to 18;
from 0 to 25% by weight of at least one semicrystalline aliphatic polyamide noted B and having an average number of carbon atoms per nitrogen atom noted C_{B}=C_{C}−1;
from 0 to 25% by weight of a semicrystalline aliphatic polyamide noted A and having an average number of carbon atoms per nitrogen atom noted C_{A}=C_{B}−1;
0% to 45% by weight of at least one impact modifier,
from 0% to 20% by weight of at least one plasticizer,
from 0% to 0.2% by weight of at least one additive,
the sum of the constituents being equal to 100%.

23. The single-layer or multilayer tubular structure (MLT) as claimed in claim 22, wherein said composition of the layer (1) is free of plasticizer and/or impact modifier.

24. The single-layer or multilayer tubular structure (MLT) as claimed in claim 22, wherein said composition of the layer (1) comprises at least one compound chosen from a plasticizer, an impact modifier and an additive.

25. The single-layer or multilayer tubular structure (MLT) as claimed in claim 9, wherein the fluid transported by said single-layer and/or multilayer tube or stored in said tank is the same as that of said single-layer or multilayer tubular structure (MLT).

26. The single-layer or multilayer tubular structure (MLT) as claimed in claim 9, wherein the fluid transported by said single-layer and/or multilayer tube or stored in said tank is different from that of said multilayer tubular structure (MLT).

27. The multilayer tubular structure (MLT) as claimed in claim 9, wherein the layer (2) consists of a composition comprising:
at least 50% by weight, of at least one semicrystalline aliphatic polyamide noted D and having an average number of carbon atoms per nitrogen atom noted CD of from 6 to 18;
from 0 to 25% by weight of at least one semicrystalline aliphatic polyamide noted E and having an average number of carbon atoms per nitrogen atom noted C_{E}=C_{D}−1;
from 0 to 25% by weight of a semicrystalline aliphatic polyamide noted F and having an average number of carbon atoms per nitrogen atom noted C_{F}=C_{E}−1;
from 3% to 45% by weight of at least one impact modifier;
from 0% to 20% by weight of at least one plasticizer;
from 0% to 0.2% by weight of at least one additive;
from 0% to 35% by weight of at least one antistatic filler;
the sum of the constituents being equal to 100%.

28. The multilayer tubular structure (MLT) as claimed in claim 27, wherein said composition of said layer (1) is free of polyamides noted A and B and said composition of said layer (2) comprises polyamides chosen from those noted E, F and a mixture thereof.

29. The multilayer tubular structure (MLT) as claimed in claim 27, wherein said composition of said layer (1) comprises polyamides chosen from those noted A, B and a mixture thereof, and said composition of said layer (2) is free of polyamides noted E and F.

30. The single-layer or multilayer tubular structure (MLT) as claimed in claim 9, wherein the layer (1) is from a recycled single-layer tube.

31. The single-layer or multilayer tubular structure (MLT) as claimed in claim 9, wherein the layer (1) is from a recycled multilayer tube.

32. The multilayer tubular structure (MLT) as claimed in claim 12, wherein the MLT consists of three layers having the following structure: (2)//(1)//(2).

33. A process for preparing a tubular structure as defined in claim 9, wherein it involves extruding the composition to constitute the layer (1), after collecting used pipes from a motor vehicle, in an extruder optionally equipped with a degassing zone.

34. The process as claimed in claim 33, wherein the used pipes are ground into granules after collection.

35. The process as claimed in claim 33, wherein the fluid residues have been extracted from the used pipes before or after grinding.

36. The process as claimed in claim 35, wherein the extraction is performed by means of washing or ventilation.

37. The process as claimed in claim 36, wherein the washing is performed using a solvent.

38. The process as claimed in claim 37, wherein the ventilation is performed using an inertized oven.

39. The process as claimed in claim 35, wherein the extraction is performed after grinding by means of a degassing zone in said extruder.

40. The process as claimed claim 35, wherein the used pipes before or after grinding are cleaned to remove any oligomers present in the used pipes.

41. A method of using a used single-layer and/or multilayer tube and/or tank which has initially transported or contained motor vehicle fluids, as defined in claim 1, for the preparation of a single-layer tubular structure intended for transporting motor vehicle fluids, said used single-layer and/or multilayer tube and/or said used tank having been ground into granules and the fluid residues present in said tube and/or tank having been totally or partially extracted, before or after grinding of said tube and/or tank and said tubular structure having during the first storage of gasoline, less than 0.3 g/m² of insoluble extract.
